(19) United States
(12) Patent Application Publication
(10) Pub. No.: US 2003/0103220 A1
(43) Pub. Date: Jun. 5, 2003

(54) Monitoring and/or controlling the forming of printed color images

(75) Inventors: Wolfgang Eberhard Luxem, Kiel (DE); Eggert Joachim Jung, Schoenberg (DE); Thomas Zelenka, Moenkeberg (DE)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/278,436

(22) Filed: Oct. 23, 2002

(30) Foreign Application Priority Data
Dec. 3, 2001 (DE) 101 58 946.8

(51) Int. Cl. B41J 1/00; G06F 15/00

(52) U.S. Cl. 358/1.9

(57) ABSTRACT

Monitoring and/or adjusting the forming of a printed color image by an image forming apparatus, preferably of a color image formed electrophotographically with toner. Light reflected or reflected back from a fixed toner image of a finished printed image is captured by a sensor device still within the image forming apparatus (online), the sensor device or its capturing result being used for controlling or adjusting the image forming process.

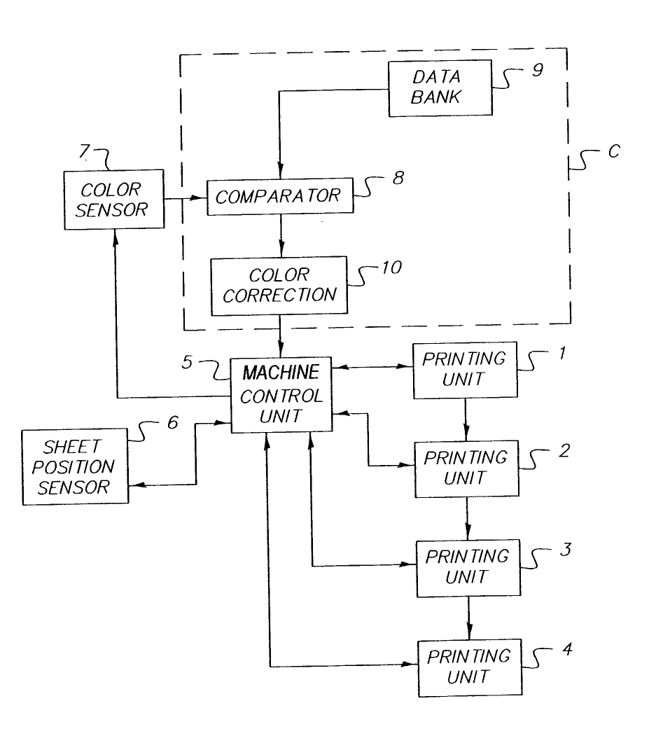

### FIELD OF THE INVENTION

The invention relates to an apparatus and method for monitoring and/or controlling the production of printed color images by an image forming apparatus, more specifically for forming a color image by the electrophotographic process with toner.

### BACKGROUND OF THE INVENTION

A color image of a printed product should have the same color impression for each item of the entire circulation. In order to achieve this, uniform color application is required among other things. Since the electrophotographic process is especially subject to changes in time, it is necessary to control the process to adjust color of the color images or the general optical appearance of the color images. In the electrophotographic process, this can be done by controlling the toner quantity. To do this, a reference sample with the 100% toner coating for each printing apparatus (for each color) is printed on a transparent transport belt for printing material or substrate, and transmission of the reference sample is measured. The difference between the transmission and the preset transmission is used to control toner application. For that purpose, it is necessary to know the relationship between the toner quantity and transmission. Parameters of the electrophotographic process such as exposure and bias voltage are adjusted in such a manner as to assure constant transmission of non-fixed (non-fused) toner.

Prior art teaches the above-described method disclosed in U.S. Pat. No. 5,805,314. The above-mentioned procedure is questionable, in that, even with the same toner quantity, the electrophotographic process produces different color impressions on different printing materials. For controlling important intermediate tone areas, it is necessary to measure at least two toner values in the light areas, e.g., with 10% toner coverage and in the medium areas, e.g., with 50% toner coverage. The same applies in principle to two-side printing methods such as, e.g., with offset printing or inkjet printing.

### SUMMARY OF THE INVENTION

The invention is based on the problem of improving production of a color image of the actual appearance for a future observer.

This problem is solved according to the invention by capturing light reflected or reflected back from a fixed toner image of a finished printed image by a sensor device still within the image forming apparatus (online), the sensor device or its capturing result being used for controlling or adjusting the image forming process.

For example, in determining transmission of the toner that has not been fixed on a transparent transport belt the actual color impression does not result in what will be seen by an observer later. The spectral reflectance of the fixed toner on a given printing material is important for the actual color impression, and the physical effect of the surface has a great influence. It is the advantage according to the invention that the reflected light from the color image on the printing material is preferably captured, however, in addition to, or as an alternative of this, a fixed toner test sample on the transport belt can also be evaluated.

For meaningful color adjustment, according to the invention, the printed image is measured when it is still in the image forming apparatus (online). In such case, the resulting color deviations can be used for fine adjustment of the electrophotographic process. In addition, a first coarse adjustment, e.g., of the toner quantity, can be done by determining transmission. This can also be used for other types of printing.

The measurements can be carried out by using a known color sensor, which measures the total light spectral distribution. The color sensor can function on a so-called tristimulus method, or it can be used with three adjoining color filters. The measured color values are sent for the process control, and they are compared with the desired preset values. When a color deviation (actual value) is found, the printing process, more specifically the electrophotographic process is then controlled in such a manner as to achieve the desired color images. A special advantage of the invention is the fact that the picture with actual appearance of the color image is measured, however, the result is obtained under conditions that are determined directly by the color impression itself, e.g., by the type of the printing material. Thus, for example, the inherent coloring of a printing material can be based on another special adjustment of the color impression calculation in order to obtain the same resulting color impression on a colored printing material as on a white printing material by factoring in the inherent color, and, which is important, this can be done automatically in the method according to the invention.

It is preferred that the measurement be conducted in a pre-selected printed image area, or a plurality of measurements be conducted in the same pre-selected printed image area. To do this, it is necessary to activate the color sensor in accordance with the position of the printing material or sheet.

With periodically occurring errors, multiple measurements in different areas of the printing material should be preferably made instead of, or in addition to, the measurements in a preset area of the printing material, with subsequent averaging of the measurement results.

Another alternative or additional embodiment of color adjustment involves calibration runs, wherein predetermined test samples are printed and are automatically obtained from special storages for use as an external process control.

A plurality of color sensors can be provided widthwise and/or lengthwise of a printed product in order to ensure simultaneous color measurement at multiple points. It is also preferred to measure the entire surface area of the printed product.

Gloss measurement can be done preferably in addition to the color measurement, which is used in addition to the color sensor for process control. It is required in such case to have a different lighting of the printed image, while the sensor for the color measurement and for the gloss measurement can be in principle the same.

The invention will now be described as applied to an example of color control of a printing machine operating based on the electrophotographic process, which can also be developed by adding further features within the scope of the invention without limiting the invention.

### BRIEF DESCRIPTION OF THE DRAWINGS

In the detailed description of the preferred embodiment of the invention presented below, reference is made to the accompanying drawing, in which:

A single FIGURE of drawings shows a block-diagram of components of an image forming apparatus for an electrophotographic printing machine according to the invention.

### DETAILED DESCRIPTION OF THE INVENTION

Referring now to accompanying drawing:

An image forming apparatus has in this embodiment four electrophotographic modules or color printing units 1 through 4. It will be understood that any other number of these units could be used.

The printing units 1 through 4 are controlled by a machine control unit 5. The machine control unit in this exemplary embodiment is connected to a sensor 6, e.g., a light emitting sensor, which is used to determine accurately the position of a sheet of printing material, e.g., in the area of the printing units 1 through 4. In combination with the sensor 6, a color sensor 7 can be activated accurately via the machine control unit 5 depending on position of the sheet of printing material, e.g., for conducting the accurate measurement of a pre-selected area of the color image.

In a computer “C”, the actual value measured by the color sensor 7 is compared in a comparator module 8 with a preset value, which has been stored in a databank 9 connected to the comparator module 8. Based on the difference between the actual value and the preset value, a necessary color correction is computed in a color correction module 10 and is sent to the machine control unit 5. This provides the necessary adjustment of the printing units 1 through 4 to further use the color corrections in the form of post-adjustment of the printing units, e.g., by adjusting the bias voltage or exposure in the process of printing.

The invention has been described in detail with particular reference to certain preferred embodiments thereof, but it will be understood that variations and modifications can be effected within the spirit and scope of the invention.

What is claimed is:

1. A method for controlling and/or adjusting the forming of a printed color image by an image forming apparatus, the method comprising the steps of: capturing light reflected from a finished printed image by a sensor device still in the image forming apparatus, and having the sensor device provide its capturing result for use in controlling or adjusting the image forming process.

2. The method of claim 1, wherein the captured light is checked against its color.

3. The method of claim 2, wherein full spectral light distribution is measured.

4. The method of claim 3, wherein the light is captured by using a tristimulus method.

5. The method of claim 4, wherein three color filters are used.

6. The method of claim 1, wherein the printed image is checked for its gloss.

7. The method of claim 1, wherein multiple measurements are conducted consecutively for the same printed image area.

8. The method of claim 1, wherein multiple measurements are conducted for a plurality of different printed image areas.

9. The method of claim 8, wherein multiple measurements are averaged.

10. The method of claim 1, wherein the printed image is measured over the entire surface area.

11. The method of claim 1, wherein a color test sample is used independently as said printed image for at least a calibration run in addition to, or instead of, direct measurement of the color image.

12. The method of claim 1, wherein a control parameter of an image forming apparatus, which operates based on the electrophotographic process, is exposure and/or bias voltage.

13. The method of claim 12, wherein transmission of a toner coating on a transparent support is used for coarse adjustment of the electrophotographic process.

14. A printing machine for producing color images, based on the electrophotographic process for forming an image with toner comprising: a sensor device for color and/or gloss monitoring of a finished printed image still in the printing machine to control or adjust the image forming process directly in the printing machine.
